(19) United States
(12) Patent Application Publication
(10) Pub. No.: US 2014/0022805 A1
(43) Pub. Date: Jan. 23, 2014

(54) FENDER

(71) Applicant: C. J. CHIU, Taipei County (TW)

(72) Inventor: C. J. CHIU, Taipei County (TW)

(21) Appl. No.: 13/550,617

(22) Filed: Jul. 17, 2012

(51) Int. Cl. B60Q 1/00; B60Q 1/26

(52) U.S. Cl. 362/506

(57) ABSTRACT

An improved fender mainly includes a fender, tunnel, and a translucent cover formed integrated. The tunnel is protruding from an inner side of the fender for receiving a LED illumination device and its wiring. The translucent cover is formed above the tunnel for revealing and diffusing the light of the LED illumination device inside the tunnel. Though the tunnel and the translucent cover, the LED illumination device is easily arranged to the fender and well protected from the climate. Moreover, the alarm and indication effect will be achieved through the translucent cover diffusing the light of the LED illumination device.

### FIELD OF THE INVENTION

The present invention relates to a fender, and particular to a fender having a tunnel and translucent cover for receiving a LED illumination device and its wiring.

### DESCRIPTION OF THE PRIOR ART

Fenders are using for shielding the rider of a bicycle or electric bicycle from dust and dirt bounced on the road. Indication devices such as an illuminating device or reflective sign are also arranged to the fenders for the purpose of safety.

Known fenders are made of plastic, synthetic fiber, acrylic, or metal. However, the PET or PC embedded by aluminum sheet of thickness about 0.05 mm are used for forming a thinner fender (about 1.5 to 2 mm) for the purpose of cost saving. Illumination device arranged to the prior fender is achieved by conducting the power through the aluminum sheets inside the fender. Referring to FIGS. 1 and 2, a plurality of aluminum sheet 10 is arranged inside the fender 1. Two of the aluminum sheets 10 are drilled for arranging pairs of conducting point 10a and 10b respectively. For the purpose of power distribution, at least two pairs of conducting points 10a and 10b must be formed to the fender 1 for conducting a power source E and an illumination device 2 respectively. Electricity power will be conducted from the aluminum sheets 10 to the illumination device 2 to light up the illumination device 2 for indication and warning. The aluminum sheets 10 inside the fender 1 can actually provide an enhancement to the structure of the fender. However, for the purpose of power distribution through the aluminum sheets, the following disadvantages and concerns must be considered.

1. Extra work for drilling on the aluminum sheets 10 and arrangement of conducting points 10a and 10b is needed for the fender 1.

2. Two separate aluminum sheets are needed for conducting the power which can cause higher cost to the fender.

3. The conducting points 10a and 10b on the fender 1 are easily rusted under exposure to the air and the rain.

### SUMMARY OF THE PRESENT INVENTION

Accordingly, the primary object of the present invention is to provide an improved fender having a tunnel inside the fender for receiving a LED illumination device and its wiring for indication and warning. A translucent cover is arranged above the tunnel for revealing and diffusing the light of the LED device inside the tunnel for illumination and indication.

To achieve above object, the present invention includes a tunnel protruding from an inner side of the fender for receiving a LED illumination device and its wiring such as a brake indicator and the wiring. A translucent cover is formed above the tunnel for revealing and diffusing the light of the LED illumination device. The fender, tunnel, and the translucent cover are formed integrated. Though the tunnel and the translucent cover, the LED illumination device is easily arranged to the fender and well protected from the climate so that the drill process and power distribution for the prior art can be skipped. The tunnel can also receive the wiring of the LED illumination device so that the conducting points for power distribution are avoided and the issue of rust is gone. Moreover, the fender, tunnel, and the translucent cover formed integrated through press molding or extruding process can also save the manufacture cost and the work for wiring.

### BRIEF DESCRIPTION OF THE DRAWINGS

FIG. 1 is a cross-section view showing a prior fender of a bicycle or electric bicycle.

FIG. 2 is a cross-section view through an A-A line in FIG. 1.

FIG. 3 is a cross-section view showing a preferable embodiment of the present invention.

FIG. 4 is a schematic view showing the preferable embodiment of the present invention.

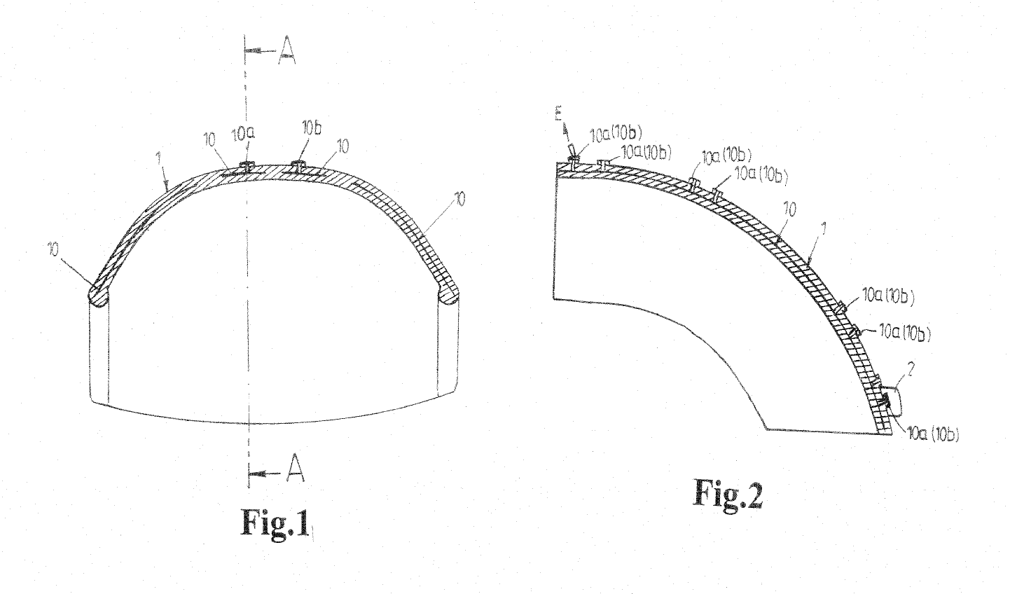

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

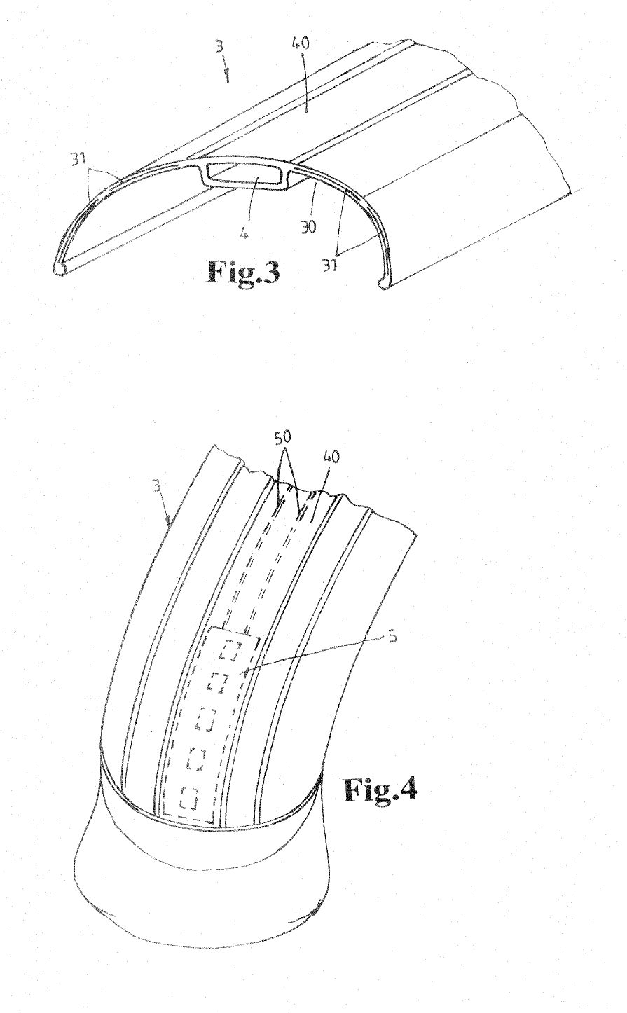

Referring to FIGS. 3 and 4, a preferable embodiment of an improved fender according to the present invention is illustrated. The fender 3 has a tunnel 4 protruding from an inner side of the fender 3. A translucent cover 40 is formed to the upper portion of the tunnel 4. The cross section of the tunnel 4 can be formed as a rectangle, square, or any other geometric shape for receiving a LED illumination device. The tunnel 4, translucent cover 40, and the fender 3 are formed integrated so as to reduce the cost and the work of wiring and a LED illumination device 5 arrangement. The translucent cover 40 will diffuse the light from the LED for indication. The translucent cover 40 can also protect the LED illumination device 5 and the wiring 50 from being damaged by the climate.

In the preferable embodiment of the present invention, the fender 3 has only two enhancing aluminum sheets 31 arranged inside the two lateral sides of the fender 3 respectively. The number of the aluminum sheet is less than the prior one and the manufacture process is also simpler than the prior one. The tunnel 4 formed to the inner side of the fender 3 is integrated with the translucent cover 40 so that the LED illumination device 5 and the wiring 50 can be received within the space inside the tunnel 4 as shown in FIG. 3. The LED illumination device 5 and the wiring 50 are arranged alone the tunnel 4. The translucent cover 40 will cover the LED illumination device 5 and the wiring 50 from being damaged by rain or external forces and also diffuse the light of the LED illumination device 5. Therefore, the LED illumination device 5 is easily arranged and well protected, the structure of the fender 3 is also strengthened and beautified.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An improved fender comprising:
a fender having a tunnel protruding from an inner side of the fender for receiving a LED illumination device;
a translucent cover formed above the tunnel for diffusing light from the tunnel;
wherein the fender, tunnel, and the translucent cover are formed integrated.

2. The improved fender as claimed in claim 1, wherein a LED illumination and its wiring are arranged inside the tunnel so as to be protected from the climate; the light of the LED illumination device will be diffused by the translucent cover for indication.

3. The improved fender as claimed in claim 1, wherein the tunnel is formed as a rectangular, cubical, elliptic, or spherical room depending on the shape of the LED illumination device arranged inside thereof.
